(19) United States
(12) Patent Application Publication
(10) Pub. No.: US 2019/0253959 A1
(43) Pub. Date: Aug. 15, 2019

(54) Cell Search and Synchronization in 5G

(71) Applicant: FUJITSU LIMITED, Kawasaki-shi (JP)

(72) Inventors: Xusheng WEI, Staines (GB); Timothy MOULSLEY, Caterham, (GB)

(73) Assignee: FUJITSU LIMITED, Kawasaki-shi (JP)

(21) Appl. No.: 16/394,476

(22) Filed: Apr. 25, 2019

Related U.S. Application Data
(63) Continuation of application No. PCT/GB2017/053052, filed on Oct. 9, 2017.

(30) Foreign Application Priority Data
Nov. 8, 2016 (GB) 1618793.2

(51) Int. Cl. H04W 48/16; H04J 11/00; H04W 56/00; H04W 24/08

(52) U.S. Cl. CPC H04W 48/16; H04W 24/08; H04W 56/001; H04J 11/0069

(57) ABSTRACT

A 5G wireless communication system will have very wide bandwidth in the extremely high carrier frequency region, more than one channel raster value is employed for wide bandwidth configurations. With this method a terminal can have a coarse initial scan for first synchronisation signals of cells over the whole available bandwidth as a first synchronization step, and obtain necessary information for a finer resolution scan to detect a second synchronization signal of a cell in the second synchronization step. Based on the second detection, the terminal can find system information needed to connect to the cell. Additionally, different synchronization sequences can be used for different carrier frequencies, hence the design and application of the synchronization sequences can take into account the properties of the carrier frequency such as delay spread and path loss. Frequency division multiplexing can be applied to synchronization sequences of neighbouring cells to avoid interference.

### CROSS REFERENCE TO RELATED APPLICATIONS

This application is a continuation application of International Patent Application No. PCT/GB2017/053052, filed Oct. 9, 2017, and claims priority to United Kingdom Patent Application No. GB1618793.2 filed Nov. 8, 2016 the contents of each are herein wholly incorporated by reference.

### FIELD

The present invention relates to a wireless communication method in which terminals connect to cells in a wireless network. The present invention further relates to a wireless communication system, a terminal, a base station and a computer program for use in said method.

Particularly, but not exclusively, embodiments herein relate to techniques for assisting a terminal in synchronizing with a cell in a “5G” wireless communication system.

### BACKGROUND

Wireless communication systems are widely known in which terminals (also called user equipments or UEs, subscriber or mobile stations) communicate with base stations (BSs) within communication range of the terminals.

The at a given carrier frequency the different geographical areas served by one or more base stations are generally referred to as cells, and typically many BSs are provided in appropriate locations so as to form a network covering a wide geographical area more or less seamlessly with adjacent and/or overlapping cells. (In this specification, the terms “system” and “network” are used synonymously). Each BS may support one or more cells and in each cell, the BS divides the available bandwidth, i.e. frequency and time resources, into individual resource allocations for the user equipments which it serves. In this way, a signal transmitted in the cell and scheduled by the BS has a specific location in the frequency and time domains. The terminals are generally mobile and therefore may move among the cells, prompting a need for handovers between the base stations of adjacent cells. A terminal may be in range of (i.e. able to detect signals from and/or communicate with) several cells at the same time, but in the simplest case it communicates with one “serving” cell.

In current, “4G” systems, also known as LTE or LTE-A, a terminal has to perform cell search and synchronization in order to connect to a cell. For this purpose, each cell broadcasts synchronization signals referred to as the Primary and Secondary Synchronization Signals (PSS/SSS). These signals establish a timing reference for the cell, and carry a physical layer cell identity and physical layer cell identity group for identifying the cell. These kinds of signals are referred to below as “synchronization sequences”.

In an LTE system, in the frequency domain, transmissions occur within at least one frequency span (frequency band) occupying a range of frequencies defined by a start frequency and an end frequency. The range of frequencies used to provide a given cell are generally a subset of those within a given frequency span. In the time domain, transmission is organized in “frames” which are subdivided into “subframes”. In one frame structure used in LTE, a 10 ms frame is divided into 10 subframes each of 1 ms duration. In LTE, each of the PSS and SSS is transmitted twice per frame, in other words with a 5 ms periodicity (and consequently, only in some subframes). For example, PSS and SSS are both transmitted on the first and sixth subframe of every frame.

In LTE specifications, a terminal can be considered as either synchronised or unsynchronised with respect to a cell. Successfully decoding the PSS and SSS allows a terminal to obtain synchronization information, including downlink timing and cell ID for a cell; in other words the terminal becomes “synchronized” with the cell. In the synchronized state, the terminal can decode system information contained in a Physical Broadcast Channel (PBCH) broadcast by the cell. The terminal can then begin to receive user data (packets) on a downlink from the cell, and/or, typically after some further protocol steps, transmit user data on an uplink to the cell.

Terminals need to measure each communication channel between itself and a given cell in order to provide appropriate feedback to that cell. To facilitate measurements of the channel by terminals, reference signals are transmitted by the cells. Various kinds of reference signal (or symbol) are provided in LTE, but for present purposes the most notable are the Common Reference Signal (CRS), which is cell specific and available to all terminals in a cell, a Channel State Information Reference Signal CSI-RS used by a terminal to report CSI feedback, and a discovery reference signal (DRS), used to replace the CRS when a cell is in the off mode.

Nowadays mobile access to Internet or another mobile point is becoming a crucial necessity for both business and personal life and there are significant challenges to the current wireless systems due to the popularity of new applications such as social networking, cloud based services and big data analysis. With the forthcoming services such as Internet of things and ultra-reliable, mission-critical connections, a next-generation system to succeed LTE/LTE-A and known as “5G” or “NR” (New Radio) will be needed to satisfy all those demanding requirements. FIG. 1 illustrates the demands which 5G systems will be required to meet (source: “Looking ahead to 5G”, Nokia White Paper).

As shown in FIG. 1, simultaneous requirements to be met comprise greatly increased traffic; many more devices; reduced latency; low-power and low-cost solutions for Machine-to-Machine (M2M) devices; and increased peak and guaranteed data rates. The intention of 5G is to satisfy all requirements of these applications and ideally, 5G could provide at least the following features:
Ultra-reliable connection in addition to higher data rate, higher capacity and higher spectral efficiency
Unified user experience together with significant reduction on latency
Scalability/adaptability to applications with significant different Quality of Service (QoS) requirements
Access all spectrum and bands and support different spectrum sharing schemes

From the properties of traffic profiles point of view, it is expected that 5G will support three profiles with significant different properties, namely:

(i) high throughput with high mobility traffic;

(ii) low-energy consumption and long lived sensor-based services; and

(iii) extremely low latency and high reliability services.

From the industry point of view, 5G will not only provide traditional voice and data services but also expand and penetrate to other industries such as automotive, agriculture, city management, healthcare, energy, public transportation etc., and all these will lead to a large ecosystem which has never experienced before.

The technical challenges for designing such a sophisticated and complicated system are tremendous and significant breakthroughs will be required both on the network side and in the radio interface. Regarding the physical layer of the radio interface, a few new techniques will be introduced in order to support aforementioned 5G requirements. One important objective of studies in 3GPP is to investigate fundamental physical layer designs such as waveform design, basic numerology and frame structure, channel coding scheme(s) and so on to meeting key 5G requirements.

Of particular relevance to certain embodiments is the impact of the available frequency spectrum available to the system, which may be a combination of multiple frequency spans. In the longer term, it is expected that much more spectrum will be available to meet traffic demand. To date, spectrum for mobile communication has focused on frequencies below 6 GHz. In the time frame of 2020 to 2030, more spectrum at higher frequencies such as 6 GHz, 10 GHz or even up to 100 GHz will be considered. At the same time wider frequency spans will be available at these extreme higher frequency bands. More detailed information is provided in Table 1 (source: Ofcom, “Spectrum above 6 GHz for future mobile communications”, February 2015).

TABLE 1
Possible spectrum allocation for 5G and beyond

| Spectrum | Possible allocation |
|---|---|
| 5 GHz | This band is being considered at the ITU World Radio Conference in 2015 |
| | (WRC-15) - in total over 300 MHz in new spectrum could be allocated |
| | If agreed at WRC-15, a contiguous band from 5150 to 5925 MHz would be |
| | created using a combination of existing and new spectrum |
| | Channel sizes likely based on current Wi-Fi use, in multiples of 20 MHz, and |
| | the band may remain as a licence-exempt band in line with current Wi-Fi |
| 15 GHz | Potentially over 500 MHz contiguous spectrum depending on the sub-band |
| | used and sharing with existing uses |
| | Very high speeds are achievable - for example, peak speeds of 5 Gbps have |
| | been demonstrated already |
| | Channel sizes could be very wide, for example, multiples of 100 MHz |
| 28 GHz | Similar to the 15 GHz band, for example, over contiguous 500 MHz of |
| | spectrum depending on the sub-band used and sharing with existing uses |
| | Channel sizes could be very wide, for example, multiples of 100 MHz |
| | Depending on the bandwidth available, the band could accommodate |
| | multiple operators with the opportunity for companies other than established |
| | mobile operators to offer some 5G services with an assignment of 100 MHz |
| | per operator, or more, depending on national availability and sharing with |
| | existing services. |
| 60-80 GHz | Potentially up to 5 GHz of contiguous spectrum depending on the selected |
| | sub-band (for example, 71-76 MHz and/or 81-86 GHz) |
| | Channel sizes could be very wide, for example, multiples of 100 MHz |
| | Depending on the bandwidth available, the band could accommodate |
| | multiple operators with the opportunity for companies other than established |
| | mobile operators to offer some 5G services with a 100 MHz assignment per |
| | operator, or more, depending on national availability and sharing with |
| | existing services. |

When considering frequency spans and channel sizes in a wireless communication system, the concept of a “channel raster” (also called “carrier raster”) is important. In general, a “raster” is a step size applied to the possible location of any signal or channel. For systems such as GSM, UMTS and LTE, a channel raster means a set of locations in the frequency domain, typically equally spaced, where the carrier centre frequency can be located. The above mentioned cell search and synchronization procedure involves a terminal receiver scanning a frequency range to detect carrier frequencies at which synchronization signals are transmitted. Thus, the distance between two consecutive places in a channel raster can be assumed as a step size when a terminal tries to search for the carrier frequency.

Unlike many previous systems, in 5G, however, it is not necessarily the case that the synchronization signals are located at the centre frequency of the carrier. More generally, the channel raster can be defined as a set of places in the frequency domain and within a frequency span at which a carrier can be found by a terminal, but such a place may or may not be the carrier centre frequency. In the description of embodiments which follows, the terms “channel raster” and “carrier raster” are used equivalently, and have this broader meaning.

In other words, the carrier/channel raster indicates the step size from one possible place for a signal which can be found by a terminal to the next possible place for a signal which can be found by a terminal. In LTE for example, where a carrier is identified by the centre frequency of the carrier, we can assume that there is a frequency span x whose spectrum is from 2000 MHz to 2010 MHz. Assuming a 5 MHz carrier bandwidth within span x and ignoring any guard bands, if the value of channel raster is 100 kHz the possible locations of a carrier centre frequency are 2002.5 MHz, 2002.6, 2002.7 . . . and so on up to 2007.5 MHz. In practice a terminal may not know the carrier bandwidth in advance, so the terminal may search at additional locations on the raster. If the channel raster value is 500 kHz, then the corresponding possible locations of the carrier centre frequency are 2002.5, 2003.0, 2003.5, 2004.0 . . . and so on up to 2007.5 MHz.

In LTE, it is possible for a terminal to communicate via more than one carrier simultaneously, for example using so-called “Carrier Aggregation” (CA) to combine a number of Component Carriers (CCs). This principle will be indispensable also in 5G in order to achieve the kinds of data rates illustrated in FIG. 1, and is likely to be extended to allow more CCs than in LTE.

Although discussions are still ongoing with respect to detailed implementation of 5G systems, it is expected that they will adopt a similar cell search and synchronization principle to that outlined above. However, with the introduction of extremely high frequencies and wider bandwidths for 5G usage in future, the impact on the radio interface design needs to be considered. There is consequently a need to devise an initial cell search and synchronization procedure suitable for 5G systems.

### SUMMARY

Enabling a terminal to have a fast cell search and synchronization process is crucial for 5G where much wider bandwidths compared with that of 4G will be available for a terminal. Enabling the selection of synchronization signals or sequences to be carrier frequency dependent will allow the synchronization procedure design to be adapted to different carrier frequencies, which may have quite different transmission properties. In previous wireless communication systems this feature does not exist, and its use will provide faster cell search, and lower complexity and power consumption at the terminal.

A first aspect of certain embodiments focuses on the manner in which a terminal scans for synchronization signals of cells, when different frequency spans may be employed by the cells.

Thus, according to the first aspect, there is provided a cell search and synchronization method of a terminal in a wireless communication system, comprising:

an initial detection comprising the terminal monitoring at least one first frequency span to detect a first signal; and

a second detection in which, based on the signal detected in the initial detection, the terminal deduces at least one second frequency span different from or identical to the at least one first frequency span and monitors the at least one second frequency span to detect a second signal providing at least one of:

a frequency associated with a cell;

system information of a cell; and

information indicative of the location of system information of a cell.

Here, preferably at least the initial detection involves the terminal monitoring a set of frequency locations spaced across said first frequency span at a first channel raster value. The “frequency associated with a cell” may be a centre frequency employed for communications in the cell, for example.

The scanning performed by the terminal is preferably, as in conventional cell search and synchronization, for the purpose of detecting synchronization signals (synchronization sequences). Thus, preferably, at least one of said first and second signals is a synchronization sequence of a cell.

More particularly, but not necessarily exclusively, the first and second signals may be primary and secondary synchronization sequences of the cell respectively. These sequences may correspond to PSS/SSS known from LTE.

To perform the method, the terminal may be preconfigured with information specifying at least one of a first channel raster value to employ for initial detection in said at least one first frequency span; and the first signal to be detected in the initial detection. However, the terminal may alternatively determine either or both of these types of information autonomously on the basis of other information available to the terminal.

Different channel rasters may be in use among the cells. Therefore, the terminal may employ a second channel raster value for monitoring the second frequency span in the second detection which is finer (i.e., a smaller interval) than a first channel raster value employed for monitoring the first frequency span in the initial detection. In this way the second detection can be a finer or more precise search in the vicinity of the first frequency.

Alternatively or in addition, the terminal may perform at least one said detection by employing more than one combination of first or second raster value and corresponding first or second signal to be detected.

In any method as defined above, preferably the first signal detected in the initial detection step provides guidance to the terminal with respect to at least one of:

frequency locations to scan in the second detection;

time locations to scan in the second detection;

a channel raster value to employ in the second detection;

the second signal to be detected in the second detection.

In one embodiment the second detection leads directly to the terminal synchronizing with a cell. For example, the second detection provides the terminal with system information of a cell which allows the terminal to connect with the cell without further searching.

Alternatively the system information may be located elsewhere than in either of the detected signals. In this case, preferably, at least one of the initial detection and the second detection provides the terminal with guidance on the frequency and/or time location of system information of the cell.

In particular an “offset” or frequency separation may be employed between system information and the first and second signals. In that case system information of the cell is broadcast at a frequency with an offset from one of said first signal or said second signal, said offset being informed to the terminal by:

being pre-configured in the terminal;

the result of the initial detection; or

the result of the second detection.

Related to the above first aspect, there is provided a wireless communication system arranged to perform the cell search and synchronization method of any preceding claim.

Further related to the first aspect, there is provided a terminal in a wireless communication system, configured to:

perform an initial detection by monitoring at least one first frequency span to detect a first signal; and

based on the signal detected in the initial detection step, deduce at least one second frequency span different from or identical to the first frequency span and perform a second detection by monitoring the second frequency span to detect a second signal and obtain at least one of:

a frequency associated with a cell;

system information of a cell; and

information indicative of the location of system information of a cell.

A second aspect of certain embodiments relates to the use of different channel rasters in a wireless communication system in dependence on a frequency span.

Thus, according to the second aspect there is provided a wireless communication system in which a channel raster value defines possible frequency locations of signals or channels, the system employing at least one frequency span with more than one channel raster value used in the same frequency span.

According to a modification of the second aspect, a wireless communication system provides a plurality of cells, each cell being associated with a respective frequency span, wherein the cells co-operate to perform wireless communication with a terminal, and each cell transmits at least one signal according to a channel raster value wherein the channel raster value is in dependence on the associated frequency span.

Here, each frequency span has a width which can be defined by the difference between a start frequency and an end frequency

Generally, but not necessarily exclusively, one cell will employ one frequency span for both its uplink and downlink communications with terminals. As already mentioned, a channel raster is a set of locations in the frequency domain where a signal or channel (or more precisely a carrier wave thereof) can be located. The term “channel raster value” is used here to denote the step size or spacing between these frequency locations.

In the above wireless communication system, preferably, the different frequency spans include a first frequency span having a first bandwidth and employing a first channel raster value, and a second frequency span having second bandwidth larger than said first bandwidth and employing a second channel raster value larger than said first channel raster value.

The concept of differing channel raster values can be applied within one and the same frequency span. Thus, in an embodiment the different frequency spans include a frequency span employing both coarse and fine (i.e., larger and smaller) channel raster values in the same frequency span. Such a frequency span is preferably the above mentioned “second frequency span” having a larger bandwidth, allowing this frequency span to be scanned more efficiently.

The cells preferably broadcast synchronization signals (synchronization sequences). In embodiments, different synchronization sequences are defined for at least two of said frequency spans. The synchronization sequences may vary, for example, in dependence on transmission properties of the respective frequency spans. Alternatively, identical synchronization sequences may be defined for at least two of said frequency spans.

The system preferably includes a terminal adapted to synchronize with the system by scanning at least one frequency span for a synchronization sequence, the scanning using a channel raster value selected from said different channel raster values.

More particularly the terminal may be adapted for scanning at least one frequency span using at least two of said channel raster values, the scanning including a first scanning using a first channel raster value to perform an initial detection and a second scanning based on said initial detection and using a second channel raster value to perform a second detection.

Preferably, the terminal performs said scanning by searching for a synchronization sequence corresponding to the or each channel raster value respectively, in a manner corresponding to the known use of PSS/SSS outlined in the introduction.

The terminal may be configured in advance with the channel raster value and synchronization sequence. Alternatively the terminal is arranged to take a decision on the channel raster value and synchronization sequence which it should employ at least for the above mentioned first scanning.

In a system as defined above, additional cells will generally be present. Even if such additional cells do not communicate with the terminal, there is the potential for mutual interference between synchronization sequences of these cells if the cells are adjacent or overlapping. Preferably therefore, the synchronization sequences employed among the set of adjacent cells are arranged to be orthogonal, which can be achieved by multiplexing them in the frequency domain and/or the time domain.

Related to the above second aspect, there is further provided a wireless communication method comprising:

providing a plurality of cells, each cell being associated with a respective frequency span;

causing the cells to co-operate to perform wireless communication with a terminal, and

each cell transmitting at least one signal according to a channel raster value wherein the channel raster value is in dependence on the associated frequency span.

The above method may include any of the features of the second aspect outlined above with respect to a wireless communication system.

Further related to the second aspect, there is provided a terminal in a wireless communication system, the system providing a plurality of cells, each cell being associated with a respective frequency span, wherein the cells co-operate to perform wireless communication with a terminal, and each cell transmits at least one signal according to a channel raster value wherein the channel raster value is in dependence on the associated frequency span, and the terminal is arranged to synchronize with the system by one of:

scanning at least one frequency span using one of said channel raster values; and

scanning at least one frequency span using at least two of said channel raster values, the scanning including a first scanning using a first channel raster value to perform an initial detection and a second scanning based on said initial detection and using a second channel raster value to perform a second detection.

Further related to the above second aspect, there is provided a base station in a wireless communication system, the system providing a plurality of cells, each cell being associated with a respective frequency span, wherein the cells co-operate to perform wireless communication with a terminal, and each cell transmits at least one signal according to a channel raster value wherein the channel raster value is in dependence on the associated frequency span, wherein the base station is arranged to transmit wireless signals employing more than one channel raster value in the same frequency span.

Here, the more than one raster value may include “coarse” and “fine” values, i.e. a relatively large step size and a smaller step size respectively.

The first and second aspects above relate primarily to individual cells and their detection by a terminal. However, a third aspect, related to the first and second aspects, considers the possibility of mutual interference between synchronization signals of adjacent cells. A method which will reduce the interference between synchronization signals is provided with the aim of improving the performance of the cell detection process.

According to the third aspect of certain embodiments, there is provided a wireless communication method in which:

a terminal communicates with any one or more of a plurality of cells,

each of the plurality of cells transmits synchronization signals, and

at least one of frequency division multiplexing, FDM, and time division multiplexing, TDM, is applied to the synchronization signals of the plurality of cells.

Here, the synchronization signals include first and second synchronization signals, the first synchronization signal being used to enable detection of the second synchronization signal, where FDM may be applied to at least the second synchronization signals.

Where FDM is applied, it can be achieved using a different frequency offset for each cell between the first synchronization signal and each second synchronization signal.

In one embodiment, the offset used for each cell is determined by at least one of the first and second synchronization signals transmitted by the cell.

It should be noted that in a special case, the offset is zero: in other words the frequency locations of the first and second synchronization signals are the same.

Related to the above third aspect, there is provided a wireless communication system comprising a terminal, in which

the terminal is arranged to communicates with any one or more of a plurality of cells,

each of the cells is arranged to transmit synchronization signals, and

at least one of frequency division multiplexing, FDM, and time division multiplexing, TDM, is applied to the synchronization signals of the plurality of cells.

Further related to the above third aspect, there is provided a base station in the above wireless communication system for providing at least one of said cells, wherein

the base station is configured to apply at least one of frequency division multiplexing, FDM, and time division multiplexing, TDM, to the synchronization signals of a cell with reference to synchronization signals of other cells.

Thus, certain embodiments address the scenario where some bands (frequency spans) of 5G will have very wide bandwidth in the extremely high frequency region. Known synchronization procedures do not target this scenario, therefore cannot operate efficiently in this new environment. Certain embodiments permit the use of different channel raster values for wide bandwidth configurations. To facilitate cell search in such a case, embodiments provide that a terminal performs a fast, coarse, initial scan for synchronisation signals which may extend over the whole of a frequency span as a first synchronization step, to obtain necessary information for a finer resolution scan to detect a second synchronization signal of a cell in the second synchronization step. Based on the second detection, the terminal can find system information needed to join the cell. Further, different synchronization sequences can be used for different carrier frequencies, hence the design and application of the synchronization sequences can take into account the properties of the carrier frequency such as path loss etc. Finally a method to reduce the interference between synchronization signals is proposed, under the assumption that more frequency domain resource will be available for synchronization sequences than in existing systems.

As will be apparent from the above, features in embodiments include:
A method which is designed for the cell search and synchronization procedure in a communication system, comprising:
   Defining different channel raster values between frequency spans with a small bandwidth and a large bandwidth
   Defining different synchronization sequences for different carrier frequencies
   Defining identical synchronization sequences for different carrier frequencies.
A terminal synchronizes with the system considering one particular raster value and using one particular synchronization sequence, based on instruction from the operator or based on its own decision.
A terminal synchronizes with the system considering all available raster values and using corresponding synchronization sequences.
A terminal uses one particular raster value and one particular synchronization sequence to perform the initial detection (first detection). After the first detection, the terminal uses another particular synchronization sequence and the information deduced from the first detection to execute a second detection process.
A terminal locates important system information after the second detection.
A terminal obtains or deduces information on where to find system information for a cell through the initial detection.

Embodiments also provide:
A method which tries to reduce the negative impact of the interference between synchronization signals, comprising:
   One or more of FDM or TDM between synchronization sequences for different cells, where preferably
   The synchronization sequences among different cells used for the second detection are made orthogonal, for example by being multiplexed in the frequency domain.

Here, synchronization sequences can include any kind of signal broadcast or transmitted by a cell in order to enable terminals to become synchronized. A known example of such signals from LTE is the above mentioned PSS/SSS. However, the present invention is not necessarily limited to PSS/SSS. Other types of signal employed in a LTE and 5G systems might also be applicable to the present invention, for example signals analogous to reference signs in LTE such as CRS and DRS.

In general, and unless there is a clear intention to the contrary, features described with respect to one aspect may be applied equally and in any combination to any other aspect, even if such a combination is not explicitly mentioned or described herein.

In this specification, the terms “span” and “band” are used interchangeably to denote a range of frequencies employed in a wireless communication system. A distinction can be made between the size or width of a span (which may be defined as the difference between start and end frequencies of the span, such as 100 MHz), and its location within the electromagnetic spectrum (start or end frequency such as 2GHz or 28GHz). In embodiments, more than one span is available simultaneously, possibly in different parts of the electromagnetic spectrum, and these may be of the same or different widths.

The term “cell” used above is to be interpreted broadly, and may include, for example, parts of a cell, a beam, or the communication range of a transmission point or access point. As mentioned earlier, cells are normally provided by base stations. Each cell is associated with a respective frequency span (also referred to below as frequency band), which is a range of wireless frequencies used by the cell. The range of frequencies used by a cell is typically a subset of those within a given frequency span and this frequency range may be equivalent to a carrier in existing systems. In addition to a frequency span, a frequency (e.g. center frequency) is associated with each cell. Base stations may take any form suitable for transmitting and receiving signals from other stations in a 5G system.

The “terminal” referred to above may take the form of a user equipment (UE), subscriber station (SS), or a mobile station (MS), or any other suitable fixed-position or movable form. For the purpose of visualising, it may be convenient to imagine the terminal as a mobile handset (and in many instances at least some of the terminals will comprise mobile handsets), however no limitation whatsoever is to be implied from this.

### BRIEF DESCRIPTION OF THE DRAWINGS

Reference is made, by way of example only, to the accompanying drawings in which:

FIG. 1 illustrates requirements for a 5G wireless communication system;

FIG. 2 shows how different raster values can be used for different bandwidths, as one feature of embodiments herein;

FIG. 3 illustrates different ways to perform a second-stage detection after an initial detection, as another feature of embodiments;

FIG. 4 is a flowchart of a synchronization procedure adopted in embodiments;

FIGS. 5 and 6 Illustrate the principle of Frequency Division Multiplexing (FDM) between synchronization sequences for different cells;

FIG. 7 is a schematic block diagram of a terminal to which certain embodiments may be applied; and

FIG. 8 is a schematic block diagram of a base station to which certain embodiments may be applied.

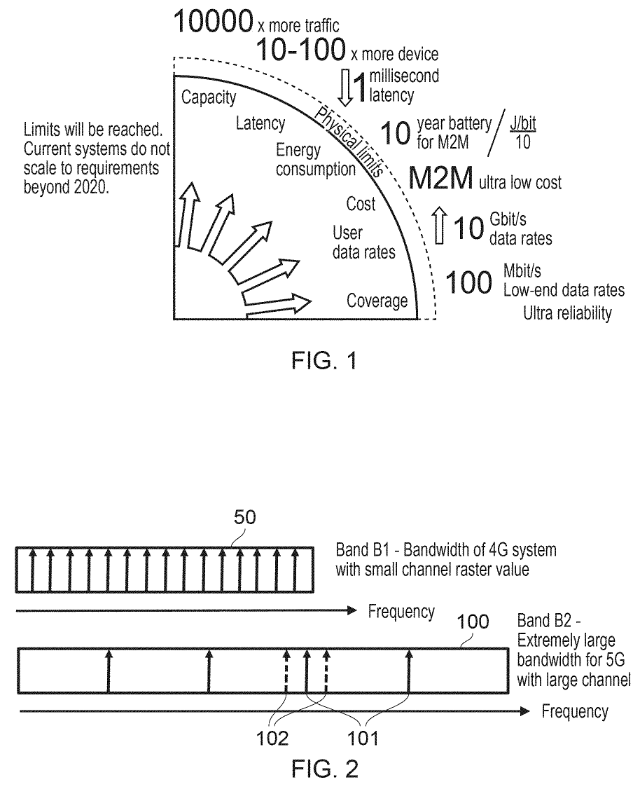

### DETAILED DESCRIPTION

When a terminal is switched on or completely loses a connection, it will typically try to connect/reconnect to a cell. At this stage that terminal may have very limited information of the possible serving cells and the local communication system(s) and will rely on a cell search/synchronization procedure, a fundamental physical layer procedure, to get the timing/frequency properties and identity information of any potential serving cells. With this information at hand, that terminal can further exploit other important system information and finish its initial access to a serving cell (e.g. by initiating a random access procedure). The following table provides a list of the main factors which should be considered during the design of the cell search/synchronization procedure.

TABLE 1
Parameters impacting the performance of the synchronization procedure

| Parameter | Design considerations | LTE design |
|---|---|---|
| Channel raster | The carrier central frequency | 100 kHz |
| | must be a multiple of channel | The same value is also used |
| | raster, a trade-off between | in UMTS |
| | fine tuning possibilities (to be | |
| | able to position a carrier with | |
| | fine resolution) and | |
| | implementation limitations in | |
| | searching for a large number | |
| | of candidate centre | |
| | frequencies. | |
| Number of synchronization | A larger number of sequences | Two stage synchronization |
| sequences | allows more information to | procedure based on PSS and |
| | be indicated by the choice of | SSS, reducing the total |
| | sequence (e.g. cell ID) | number of different candidate |
| | | sequences to be processed. |
| | | The transmitted PSS and SSS |
| | | sequences together indicate |
| | | the cell ID |
| Synchronization signal | Good autocorrelation and | PSS signal is constructed |
| sequence design | cross-correlation properties to | based on Zadoff-Chu |
| | allow overlapping sequences | sequence. SSS signal is |
| | to be distinguished | based on M sequences. |
| | Sequence length is a | |
| | compromise between | |
| | detection performance, | |
| | detection complexity and | |
| | resource usage | |
| Frequency and time domain | This may be a compromise | Frequency domain location is |
| location of the | between minimising the | fixed, PSS and SSS are |
| synchronization signal | number of possible locations | transmitted in the central 6 |
| | to search and controlling the | resource blocks of a carrier. |
| | interference between different | Transmitted periodically, |
| | synchronization signals. | twice per radio frame (10 ms), |
| | The density of | the location of PSS and |
| | synchronisation signal | SSS are fixed within each |
| | transmission in the time | radio frame |
| | domain should be sufficient | With fixed locations in the |
| | to allow reasonable cell | time and frequency domains, |
| | search within a reasonable | sequences from synchronised |
| | amount of time, and to track | cells will overlap and |
| | possible changes in the | distinguishing different |
| | channel time delay (e.g. due | sequences relies on the |
| | to UE mobility). | number of different |
| | | sequences and their |
| | | correlation properties. |
| Resources occupied by | Longer synchronisation | With fixed locations in the |
| synchronisation signals | sequences are easier to detect | time and frequency domains, |
| | and can support a larger | sequences from synchronised |
| | number of different | cells will overlap, but this |
| | sequences, but this would use | uses less time/frequency |
| | more time/frequency resource | resource. |
| Relationship of | Once synchronization | When PSS and SSS are |
| synchronisation signals to | sequences for a cell are | received the UE knows cell |
| other signals | detected by a UE, it needs to | ID, carrier centre frequency |
| | be able to identify the | and subframe timing. This |
| | location/characteristics of | information is required for |
| | other signals, for example | reception of PBCH. |
| | common reference signals | |
| | and PBCH (broadcast | |
| | channel carrying basic system | |
| | information) | |

Those parameters will be jointly considered during the synchronization procedure design. For example if we consider a two-step synchronization procedure, then one solution is to have both PSS and SSS, as in the current LTE synchronization procedure. Considering the aforementioned spectrum allocation for 5G and compared with the spectrum usage situation of LTE, the following items should be considered when determine whether to reuse the LTE synchronization procedure or design a new synchronization procedure for 5G system.

Firstly, as already mentioned the bandwidth of 5G could be much larger compared with the design target of 20 MHz transmission bandwidth of LTE. Without any help from some prior information the receiver would potentially need to check all possible carrier frequencies on the carrier raster. In general, the number of possible raster locations in a given frequency band (supporting a few carriers) will be proportional to the transmission bandwidth multiplied by number of possible carriers, divided by the frequency raster. For 5 carriers in LTE this number could be something like 5×20/0.1=1000. Assuming a total bandwidth in 5G/NR of some multiple of 100 MHz this number could be much higher (e.g. 10×100/0.1=10000 assuming 10 carriers), and the implementation complexity and the tuning time when searching the whole bandwidth will be significantly increased compared with LTE using a 100 kHz channel raster. In addition, the introduction of NR/5G is likely to increase the number of possible frequency bands which should be searched for synchronisation sequences.

Secondly, the carrier frequency of 5G/NR could be much higher compared with the LTE carrier frequency. The path loss when using these higher carrier frequencies is increased, which will limit/reduce the size of a cell. Smaller cells imply fewer users per cell, and with a larger bandwidth it will be possible to use more resources in the frequency domain to accommodate the synchronization signals (e.g. by use of different frequencies), which will make it possible to reduce the interference between synchronization signals from different cells.

Certain embodiments will be described with reference to a 5G/NR system which is assumed to share many characteristics with LTE.

A first embodiment is based on the principle of employing different raster spacings for different bandwidths (carriers or CCs) available to a terminal. For example a carrier with a typical bandwidth 10 MHz in 4G/LTE will use the current defined raster value 100 kHz whereas a 5G/NR carrier with an extremely large bandwidth can have a large raster value to keep a reasonably small number of possible carrier locations. The terminal (henceforth referred to as a UE) may determine the appropriate raster in different ways, such as:
Prior knowledge of the raster to be assumed for a particular frequency band (or part of a frequency band) e.g. defined in specification or pre-stored (e.g. on a SIM card).
Signalling (via a carrier on a different frequency) indicating the raster to be applied
Blind detection: Making an initial search with a coarse raster and if this fails making a subsequent search with a fine raster

As an extension to the first embodiment, both a large raster channel value and a traditional small channel raster value can be employed for the 5G carrier at the same time, as shown in FIG. 2.

In FIG. 2 (and also in subsequent Figures), the horizontal direction is a frequency axis, and the vertical arrows represent signals transmitted at particular frequencies. The upper part of the Figure shows the raster pattern 50 for a 4G carrier (Band B1), which is unchanged. Indicated at 100 is a novel raster pattern 100 for a 5G carrier (Band B2) consists of a coarse raster indicated by the solid arrows 101, with some additional possible carrier locations with a fine raster around the coarse locations (as shown by the dashed arrows 102). In other words, two raster spacings are employed simultaneously in the same frequency band. This allows for some fine adjustment without too many different possible frequencies to search.

It should be noted that FIG. 2 only indicates a few possible locations 101 for signals indicating the presence of a carrier on coarse raster, which enables a UE to have a quick scan. The actual carrier centre frequency can be on a frequency determined by a fine raster, allowing the carrier to be placed optimally (e.g. with respect to the spectrum allocation for the operator).

In the first embodiment, identical synchronization sequences can be used for different raster values. In other words the same synchronization sequences are transmitted at both the “coarse raster” and “fine raster” frequencies. In addition, depending on the properties of the carrier frequency, different synchronization signals or sequences can be used which are optimized for different carrier frequencies. This is desirable since the radio channel characteristics can vary significantly with frequency band and deployment scenario. When a terminal executes the initial detection process on a particular frequency band for synchronization purpose, some possible options are:
follow a priori information, such as operator's information stored in the SIM card, to determine which synchronization signal/sequence and raster value to use for the search,
autonomously determine which is the first raster value and synchronization signal/sequence which the terminal will use for synchronization purposes,
use more than one combination of the raster value and corresponding synchronization sequence at the same time to scan the whole spectrum.

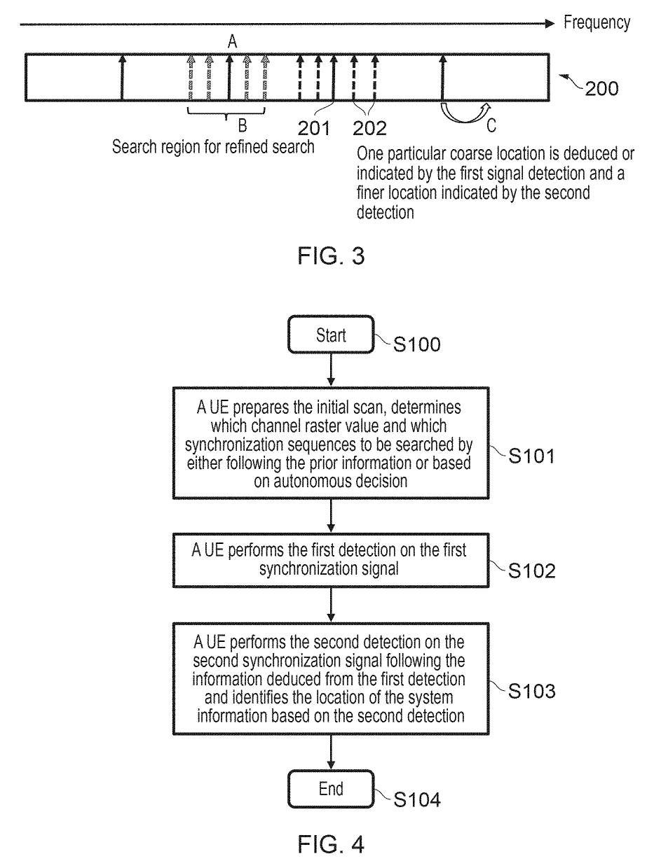

FIG. 3 shows alternative ways in which a terminal can perform a second detection after an initial detection of a synchronization signal within a frequency band 200. In general a particular location in the frequency domain (represented as frequency point A in FIG. 3, for example) and a particular location in the time domain will be found after the initial detection process (the first step of the synchronization procedure).

In a second embodiment the initial detection process is similar to the first embodiment, using a coarse raster indicated by solid arrows 201. After that a terminal can carry out a scan with finer resolution (the second scanning step) searching for another synchronization sequence at a location indicated by one of the dashed arrows 202. The intention of this second scan/detection process is to find a more precise location within a search in the frequency and/or time domain region for a refined search (indicated at B in FIG. 3). The first detection may be based on a signal like PSS in LTE and the second detection may be based on a signal like SSS in LTE. In the basic version of the second embodiment, the centre frequency of the carrier may be indicated by location B. PSS will be broadcast at frequency A, and SSS at frequency B.

In a variation of the second embodiment, the centre frequency of the carrier is indicated by location A, and the location B is used to identify the location in the time/frequency domain of other important system information (e.g. PBCH). This is contrast to LTE where A and B are identical and PBCH is located with a fixed time/frequency offset with respect to A. The indirect nature of the wording “used to identify” allows for the fact that other important system information could be located at a different location, other than location A and B, whose location can be deduced after a UE finds locations A and B.

In a further variation, which may also apply to the first embodiment, the selection of a particular synchronization sequence provides at least part of the information to enable a terminal to deduce the location other important system information. For example, the time/frequency offset from PSS or SSS to PBCH can be signalled using PSS/SSS (different offsets will generally apply from PSS to PBCH and from SSS to PBCH, since PSS/SSS are no longer at the same frequency).

The scanning range in the frequency domain of the second detection process can be based on a pre-defined offset around frequency point A, as shown by the dashed arrows B at the left-hand side of FIG. 3. Alternatively a UE can directly scan some particular locations at the frequency domain with the help of information derived from the first detection process, for example, that UE can scan around frequency point A using an offset derived from the first detection process, as shown by the curved arrow C at the right-hand side of FIG. 3. In this alternative, one particular coarse location is deduced from or indicated by the first signal detection.

A flowchart of an example of the synchronization procedure followed by a UE attempting to gain initial access is shown in FIG. 4.

The process starts at S100. In step S101 the UE prepares the initial scan, determines which channel raster value and which synchronization sequences to be searched, either by following prior-obtained information or based on its own decision. In step S102, the UE performs the first detection on the 1st synchronization sequence so as to obtain guidance for the subsequent process. In step S103 the UE performs the second detection on the second synchronization signal following the information deduced from the first detection and identifies the location of the system information based on the second detection. At S104, the cell search and synchronization ends with the UE synchronized to the cell and able to receive and/or transmit user data.

As mentioned previously, one example case is where a 1st synchronization sequence, namely the synchronization sequence used for the first detection process, is located according to a coarse frequency raster but is not necessarily located at the centre of the spectrum allocated for one particular operator. However, a 2nd synchronization sequence, namely the synchronization sequence for the second detection process, is located at the central carrier frequency.

In a variation of the second embodiment a UE can find important system information directly with the help of information extracted by the first detection process. Some possible options are:
A fixed offset of the 1^{st} synchronization sequence with respect to the system information (like in LTE)
The terminal deduces an offset value from the 1st synchronization sequence.

The synchronization procedure is one of the most important physical layer procedures which allows a terminal to obtain the timing and frequency information of the system. Any methodology which can improve the reliability/robustness of the synchronization procedure is strongly preferred. Since before the synchronization procedure, a terminal may know almost nothing about the system configuration, it is difficult to use any interference management techniques at the UE, such as interference mitigation or interference avoidance, to improve the quality of the synchronization process. However based on the procedures in the second embodiment, after the first detection process the search region for the second detection process, both in the frequency domain and/or in the time domain, will be limited, which means for different cells, FDM (frequency domain multiplexing) or TDM (time domain multiplexing) can be introduced for the synchronization sequences for the second detection process, with only a modest increase in the detection process complexity.

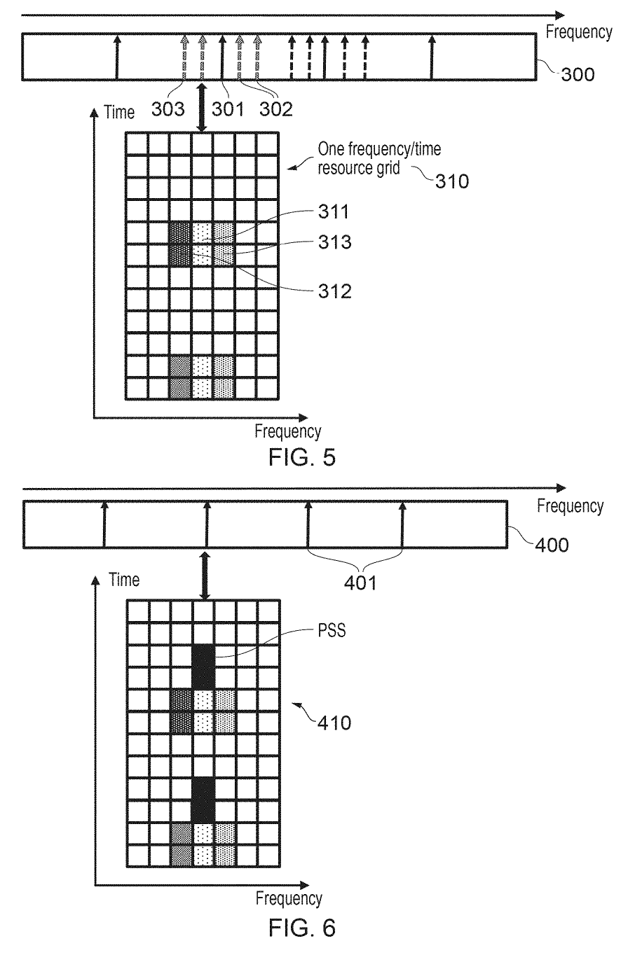

A third embodiment, based on the second embodiment, aims at reducing the negative impact of the interference among synchronization sequences of different cells during the second detection process. The synchronization sequences of different cells can be said to be “orthogonal” if they do not cause mutual interference, in other words if they have no influence on one another. This can be achieved for example by making the synchronization sequences of each cell frequency domain-multiplexed. One implementation example is shown in FIG. 5.

FIG. 5 illustrates the use of FDM between synchronization sequences for different cells. In this case the frequency band 300 is shown together with a corresponding resource grid 310, in which the horizontal direction represents frequency, the vertical direction represents time, and the small squares each represent a resource element, i.e. a unit of resource allocation in the system. The resource grid occupies a small fraction of the frequency bandwidth available in carrier 300.

In this example the PSS (centre carrier frequency) can be located on any one of the coarse raster locations shown by solid arrows 301, while the SSS of each cell is located with a frequency offset from the PSS at locations shown by the dashed arrows 302 and 303. Different cells have different possible offsets, indicated by the lighter (leftmost) and darker (rightmost) dashed arrows in the upper part of the Figure. It can be assumed that each cell has a carrier frequency the same as the frequency of its SSS.

The resource grid 310 in the lower part of the figure illustrates resource allocation in the time/frequency domain around one particular dashed arrow 303. The resource elements indicated at 311 are located at the frequency of arrow 303, as indicated by the double-headed arrow.

For example with a 200 kHz channel raster, channels may be located at 2000 MHz, 2000.2 MHz, 2000.4 MHz, 2000.8 MHz etc. Assuming that arrow 303 represents a carrier at 2000.2 MHz, the resource grid 310 shows the situation around 2000.2 MHz. If each resource element occupies 15 KHz, then the grid square 312 is at 2000.185 (2000.2-0.015) MHz and that marked 313 is at 2000.215 (2000.2+0.015) MHz. It will be noted that these locations are considerably spaced apart from the raster before (which is 2000 MHz) or after (which is 2000.4 MHz).

When introducing FDM between synchronization sequences of different cells, the design target is to achieve a good trade-off between various factors such as the FDM gain, the implementation complexity and limiting the number of synchronization sequences. In one form of this embodiment, neighbour cells such as co-located cells have their synchronization sequences multiplexed in the frequency domain, whereas the same frequency resource can be reused by cells which have enough distance between each other. For example, assuming a traditional eNB site configuration with three sectors, and one cell per sector, one implementation is to have a frequency reuse factor of 3 for SSS, i.e., FDM is applied to the secondary synchronization sequences of the cells supported from the same site. The centre of the carrier frequency, indicated at 311 in FIG. 5, is obtained through the first detection (detection of the 1st synchronization sequence, e.g. PSS). The 2^{nd} synchronization sequences of different cells (e.g. SSS) can occupy neighbouring locations in the frequency/time grid with frequencies offset from the centre of the carrier frequency, namely the locations of the lightest-shared squares in the resource grid in FIG. 5. The frequency/time grid can be defined based on a combination of a few minimum frequency/time units defined for 5G. In this way, a reasonable degree of interference mitigation can be obtained with a limited burden on extra frequency resource consumption and implementation complexity. Different variations of the third embodiment are possible, for example:
The time/frequency offset of the second sequence is determined by the sequence used for the first sequence. In this case the UE knows the offset as soon as the first stage is completed.
The time/frequency offset of the second sequence is determined by the second sequence itself. In this case the UE should blindly check for appropriate sequences at locations corresponding to the possible offsets.
The possible frequency locations of second sequences can include the location of the first sequence. For example the first sequence may be located on the carrier raster, and the second sequence may have a small offset from the first sequence, as shown in FIG. 6.

FIG. 6 illustrates an example of FDM between synchronization sequences for different cells, in which the PSS is located on the carrier frequency raster 401 of frequency band 400, while the SSS may have small frequency offset from the PSS (but transmitted at a different time). Different cells have different possible offsets.

Thus, FIG. 6 illustrates the special case where the location of PSS is the same as one of the SSS, i.e., the offset between PSS and SSS is zero (see resource grid 410), and consequently, in contrast to FIG. 5, the dashed arrows are not distinguishable in the frequency spectrum 400.

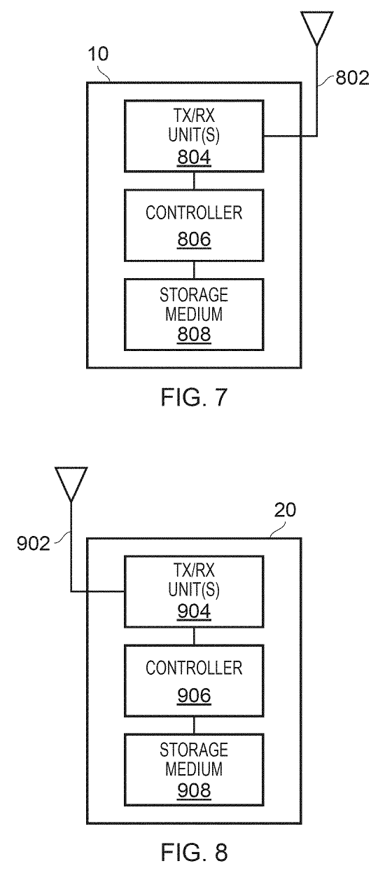

FIG. 7 is a block diagram illustrating an example of a terminal 10 to which certain embodiments may be applied. The terminal 10 may include any type of device which may be used in a wireless communication system described above and may include cellular (or cell) phones (including smartphones), personal digital assistants (PDAs) with mobile communication capabilities, laptops or computer systems with mobile communication components, and/or any device that is operable to communicate wirelessly. The terminal 10 includes transmitter/receiver unit(s) 804 connected to at least one antenna 802 (together defining a communication unit) and a controller 806 having access to memory in the form of a storage medium 808. The controller 806 may be, for example, a microprocessor, digital signal processor (DSP), application-specific integrated circuit (ASIC), field-programmable gate array (FPGA), or other logic circuitry programmed or otherwise configured to perform the various functions described above, including performing the cell search and synchronization procedure such as that shown in FIG. 4. For example, the various functions described above may be embodied in the form of a computer program stored in the storage medium 808 and executed by the controller 806. The transmission/reception unit 804 is arranged, under control of the controller 806, to receive synchronization signals from cells, and subsequently to receive PBCH as discussed previously. The storage medium 808 stores the synchronization information so obtained.

FIG. 8 is a block diagram illustrating an example of an eNB 20 responsible for one or more cells. The base station includes transmitter/receiver unit(s) 904 connected to at least one antenna 902 (together defining a communication unit) and a controller 906. The controller may be, for example, a microprocessor, DSP, ASIC, FPGA, or other logic circuitry programmed or otherwise configured to perform the various functions described above. For example, the various functions described above may be embodied in the form of a computer program stored in the storage medium 908 and executed by the controller 906. The transmission/reception unit 904 is responsible for broadcasting synchronization signals, PBCH and so forth, under control of the controller 906.

Various modifications are possible within the scope of the present invention.

The above embodiments have been described with respect to “synchronization sequences” on the assumption that 5G/NR will adopt similar sequences (in other words, patterns) of synchronization signals as are already used in LTE. However, the present invention can be applied even if synchronization signals do not form a synchronization sequence in the currently-understood sense.

The above description assumes that cells are “on”, in other words broadcasting their normal signals such as PSS/SSS allowing a UE to synchronize to the cells. However, the present invention may also be applied in the case where cells are in a power-saving mode, in which the normal synchronization sequences are not transmitted but other signals such as the above mentioned DRS proposed for LTE, are still broadcast. In such a case, the principle of the invention would be applied instead to these other signals.

Although “coarse” and “fine” raster spacings are referred to above, such that two raster spacings are in use, the present invention is not limited to using two raster spacings. The principle of the invention can be extended to the use of three or more rasters if desired, and as already mentioned these can be applied either to different frequency bands, and/or simultaneously in the same frequency band.

The invention is equally applicable to FDD and TDD systems, and to mixed TDD/FDD implementations (i.e., not restricted to cells of the same FDD/TDD type). References in the claims to a “terminal” are intended to cover any kind of user device, subscriber station, mobile terminal and the like and are not restricted to the UE of LTE.

The term “cell” is to be interpreted broadly and includes parts of a cell, a beam, and the coverage area of an access point, transmission point or other network node.

In any of the aspects or embodiments described above, the various features may be implemented in hardware, or as software modules running on one or more processors. Features of one aspect may be applied to any of the other aspects.

Certain embodiments also provide a computer program or a computer program product for carrying out any of the methods described herein, and a computer readable medium having stored thereon a program for carrying out any of the methods described herein.

The computer program may be stored on a computer-readable medium, or it may, for example, be in the form of a signal such as a downloadable data signal provided from an Internet website, or it may be in any other form.

It is to be clearly understood that various changes and/or modifications may be made to the particular embodiment just described without departing from the scope of the claims.

### INDUSTRIAL APPLICABILITY

Enabling a terminal to have a fast cell search and synchronization process is crucial for 5G where much wider bandwidths compared with that of 4G will be available for a terminal. Enabling the selection of synchronization signals or sequences to be carrier frequency dependent will allow the synchronization procedure design to be adapted to different carrier frequencies, which may have quite different transmission properties, to allow faster cell search and lower complexity and power consumption at the terminal. Further, by reducing the interference between synchronization signals the performance of the cell detection process is improved.

What is claimed is:

1. A cell search and synchronization method of a terminal in a wireless communication system, comprising:
an initial detection comprising the terminal monitoring at least one first frequency span to detect a first signal; and
a second detection in which, based on the first signal detected in the initial detection, the terminal deduces at least one second frequency span different from or identical to the at least one first frequency span and monitors the at least one second frequency span to detect a second signal providing at least one of:
a frequency associated with a cell;
system information of a cell; and
information indicative of the location of system information of a cell.

2. The cell search and synchronization method according to claim 1 wherein in the initial detection the terminal monitors a set of frequency locations spaced across said first frequency span at a first channel raster value.

3. The cell search and synchronization method according to claim 1 wherein at least one of said first and second signals is a synchronization sequence of a cell.

4. The cell search and synchronization method according to claim 3 wherein the first and second signals are primary and secondary synchronization sequences of the cell respectively.

5. The cell search and synchronization method according to claim 1 wherein the terminal is preconfigured with information specifying at least one of:
a first channel raster value to employ for initial detection in said at least one first frequency span; and
the first signal to be detected in the initial detection.

6. The cell search and synchronization method according to claim 1 wherein the terminal determines for itself at least one of:
a first channel raster value to employ in the initial detection; and
the first signal to be detected in the initial detection.

7. The cell search and synchronization method according to claim 1 wherein a second channel raster value employed for monitoring the second frequency span in the second detection is smaller than a first channel raster value employed for monitoring the first frequency span in the initial detection.

8. The cell search and synchronization method according to claim 7 wherein the terminal performs at least one said detection by employing more than one combination of first or second raster value and corresponding first or second signal to be detected.

9. The cell search and synchronization method according to claim 1 wherein the first signal detected in the initial detection provides guidance to the terminal with respect to at least one of:
frequency locations to scan in the second detection;
time locations to scan in the second detection;
a channel raster value to employ in the second detection; and
the second signal to be detected in the second detection.

10. The cell search and synchronization method according to claim 1 wherein the second detection leads directly to the terminal synchronizing with a cell.

11. The cell search and synchronization method according to claim 1,
wherein at least one of the initial detection and the second detection provides the terminal with guidance on the frequency and/or time location of system information of the cell, and
wherein system information of the cell is broadcast at a frequency with an offset from one of said first signal or said second signal, said offset being informed to the terminal by:
being pre-configured in the terminal;
the result of the initial detection; or
the result of the second detection.

12. A terminal in a wireless communication system, comprising:
processor circuitry and memory, the processor circuitry configured to:
perform an initial detection by monitoring at least one first frequency span to detect a first signal; and
based on the first signal detected in the initial detection, deduce at least one second frequency span different from or identical to the first frequency span and perform a second detection by monitoring the second frequency span to detect a second signal and obtain at least one of:
a frequency associated with a cell;
system information of a cell; and
information indicative of the location of system information of a cell.

13. The terminal according to claim 12 wherein the processor circuitry is further configured to:
in the initial detection, monitor a set of frequency locations spaced across said first frequency span at a first channel raster value, wherein
the first channel raster value defines possible frequency locations of signals or channels, the terminal employing at least one frequency span with more than one channel raster value used in the same frequency span.

14. A wireless communication system comprising:
a plurality of cells, each cell of the plurality being associated with a respective frequency span, wherein the cells co-operate to perform wireless communication with a terminal, and each cell of the plurality transmits at least one signal according to a channel raster value wherein the channel raster value is in dependence on the associated frequency span.

15. The wireless communication system according to claim 14 wherein the respective frequency spans include a first frequency span having a first width and employing a first channel raster value, and a second frequency span having second width larger than said first width and employing a second channel raster value larger than said first channel raster value.

16. The wireless communication system according to claim 14, wherein
the second frequency span employs more than one channel raster value, and
each of the cells of the plurality is arranged to broadcast a synchronization sequence and different synchronization sequences are defined for at least two of said frequency spans.

17. The wireless communication system according to claim 14 wherein each of the cells of the plurality is arranged to broadcast a synchronization sequence and identical synchronization sequences are defined for at least two of said frequency spans.

18. A terminal in a wireless communication system, the system providing a plurality of cells, each cell being associated with a respective frequency span, wherein the cells co-operate to perform wireless communication with a terminal, and each cell transmits at least one signal according to a channel raster value wherein the channel raster value is in dependence on the associated frequency span, the terminal comprising:
processor circuitry and memory, the processor circuitry configured to:
synchronize with the system by one of:
scanning at least one frequency span using one of said channel raster values; and
scanning at least one frequency span using at least two of said channel raster values, the scanning including a first scanning using a first channel raster value to perform an initial detection and a second scanning based on said initial detection and using a second channel raster value to perform a second detection.

19. The terminal according to claim 18 wherein the terminal performs said scanning by searching for a synchronization sequence corresponding to each channel raster value respectively.

20. The terminal according to claim 19 wherein the terminal is configured in advance with at least one channel raster value and a corresponding synchronization sequence.
